(19) United States
(12) Patent Application Publication
(10) Pub. No.: US 2026/0147155 A1
(43) Pub. Date: May 28, 2026

(54) OPTICAL COUPLERS FOR PHOTONIC INTEGRATED CIRCUITS

(71) Applicant: Lightmatter, Inc., Boston, MA (US)

(72) Inventors: Omkar Karhade, Chandler, AZ (US); Joyce Poon, Toronto (CA); Sandeep Sane, Chandler, AZ (US); Shashank Gupta, Gurugram (IN); Darius Bunandar, Boston, MA (US)

(73) Assignee: Lightmatter, Inc., Boston, MA (US)

(21) Appl. No.: 19/400,498

(22) Filed: Nov. 25, 2025

Related U.S. Application Data
(60) Provisional application No. 63/725,211, filed on Nov. 26, 2024.

(51) Int. Cl. G02B 6/122; G02B 6/13

(52) U.S. Cl. CPC G02B 6/122; G02B 6/13

(57) ABSTRACT

Described herein are fiber-connection structures for photonic integrated circuits (PICs). These fiber connection structures enable efficient optical coupling between integrated waveguides and corresponding optical fibers by facilitating reliable edge coupling. The fiber-connection designs developed by the inventor improve upon conventional approaches by increasing fan-out fiber capability, coupling efficiency and scalability. A photonic package comprises a substrate, a PIC, an application-specific integrated circuit (ASIC) and a glass coupler. The PIC is attached to the substrate and comprises a PIC waveguide having an end adjacent an edge of the PIC. The ASIC is attached to the PIC. The glass coupler is attached to the PIC and comprises a glass waveguide optically coupled to the PIC waveguide.

### CROSS-REFERENCE TO RELATED APPLICATION

This application claims the benefit of U.S. Provisional Application Ser. No. 63/725,211, filed on Nov. 26, 2024, under Attorney yyocket No. L0858.70106US00 and entitled “PHOTONIC INTEGRATED CIRCUITS PACKAGED WITH GLASS,” which is hereby incorporated herein by reference in its entirety.

### BACKGROUND

Photonic integrated circuits (PICs) are devices that integrate multiple photonic components, such as waveguides, detectors, switches and modulators, on a single substrate. Similar to how electronic integrated circuits manipulate electrical signals, PICs manipulate light to transmit, process and detect information at high speeds and with low power consumption.

PICs are increasingly used in applications such as optical communications, data centers, sensing and quantum computing. Integration of photonic components on a common platform enables compact size, reduced cost, improved performance, and enhanced scalability.

### BRIEF SUMMARY

In some aspects, the techniques described herein relate to a photonic package, including: a substrate; a first photonic integrated circuit (PIC) attached to the substrate, wherein the first PIC includes a PIC waveguide having an end adjacent an edge of the first PIC; an application-specific integrated circuit (ASIC) attached to the first PIC, wherein the ASIC and the first PIC are electrically coupled to one another; and a glass coupler attached to the first PIC, the glass coupler including a glass waveguide optically coupled to the PIC waveguide.

In some aspects, the techniques described herein relate to a photonic package, wherein the ASIC and the glass coupler are attached to a same surface of the first PIC.

In some aspects, the techniques described herein relate to a photonic package, further including a dielectric material near the edge of the first PIC, wherein the glass coupler is disposed in part on the dielectric material.

In some aspects, the techniques described herein relate to a photonic package, wherein the glass waveguide and the PIC waveguide are on different planes and are coupled to each other evanescently.

In some aspects, the techniques described herein relate to a photonic package, wherein the glass waveguide and the PIC waveguide are separated by less than 10 um.

In some aspects, the techniques described herein relate to a photonic package, wherein the first PIC is less than 50 um in thickness, and wherein the first PIC includes a through silicon via (TSV) coupled to the ASIC. 7 The photonic package, wherein the first PIC defines a recess and wherein the glass coupler is partially disposed in the recess.

In some aspects, the techniques described herein relate to a photonic package, further including an optical assembly including an optical fiber attached to a fiber array unit (FAU), wherein the glass coupler optically couples the optical assembly to the first PIC.

In some aspects, the techniques described herein relate to a photonic package, wherein the edge of the first PIC has a first length, and wherein the optical assembly is attached to an edge of the glass coupler, wherein the edge of the glass coupler has a second length greater than the first length.

In some aspects, the techniques described herein relate to a photonic package, further including a second PIC attached to the substrate, wherein the second PIC includes a PIC waveguide having an end adjacent an edge of the second PIC, wherein: the glass coupler is disposed between the first PIC and the second PIC, and the glass waveguide optically couples the PIC waveguide of the first PIC to the PIC waveguide of the second PIC.

In some aspects, the techniques described herein relate to a photonic package, further including a glass support, wherein the first PIC and the glass coupler are attached to the glass support.

In some aspects, the techniques described herein relate to a photonic package, including: a substrate; first and second photonic integrated circuits (PICs) attached to the substrate; a first application-specific integrated circuit (ASICs) attached to the first PIC and a second ASIC attached to the second PIC; an optical assembly including an optical fiber attached to a fiber array unit (FAU); a first glass coupler attached to the first PIC, the first glass coupler optically coupling the optical assembly to the first PIC; and a second glass coupler attached to the first and second PICs, the second glass coupler optically coupling the first PIC to the second PIC.

In some aspects, the techniques described herein relate to a photonic package, wherein the first ASIC, the first glass coupler and the second glass coupler are attached to a same surface of the first PIC.

In some aspects, the techniques described herein relate to a photonic package, wherein the first glass coupler and the first PIC are coupled to each other evanescently.

In some aspects, the techniques described herein relate to a photonic package, wherein: an edge of the first PIC, to which the first glass coupler is attached, has a first length, and the optical assembly is attached to an edge of the first glass coupler, wherein the edge of the first glass coupler has a second length greater than the first length.

In some aspects, the techniques described herein relate to a photonic package, wherein the first PIC is less than 50 um in thickness, and wherein the first PIC includes a through silicon via (TSV) coupled to the first ASIC.

In some aspects, the techniques described herein relate to a method for fabricating a photonic package, the method including: obtaining a photonic integrated circuit (PIC) having a PIC waveguide and a through silicon via (TSV), and obtaining a glass coupler having a glass waveguide; exposing the TSV by grinding the PIC; forming a conductive pad electrically coupled with the TSV; attaching an application-specific integrated circuit (ASIC) on the PIC such that the ASIC is electrically coupled to the conductive pad; attaching the glass coupler to the PIC such that the glass waveguide is optically coupled to the PIC waveguide; and attaching a fiber to the glass coupler such that the glass waveguide is optically coupled to the fiber.

In some aspects, the techniques described herein relate to a method, further including attaching a capping structure on the ASIC such that the capping structure covers the ASIC and the glass coupler.

In some aspects, the techniques described herein relate to a method, wherein attaching the glass coupler to the PIC includes attaching the glass coupler to a recess formed in the PIC.

In some aspects, the techniques described herein relate to a method, wherein upon attaching the glass coupler to the PIC, the glass waveguide is evanescently coupled to the PIC waveguide.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in the figures in which they appear.

FIG. 1A is a cross sectional side view of a package including glass couplers, in accordance with some embodiments.

FIG. 1B is a top view illustrating the package of FIG. 1A, in accordance with some embodiments.

FIG. 2A is a cross sectional side view of another package including glass couplers, in accordance with some embodiments.

FIG. 2B is a top view illustrating the package of FIG. 2A, in accordance with some embodiments.

FIG. 3 is a cross sectional side view of a package including glass couplers attached to a glass support, in accordance with some embodiments.

FIGS. 4A-4H are cross sectional views illustrating a process for fabricating a package, in accordance with some embodiments. In the fabrication step corresponding to FIG. 4A, a photonic integrated circuit (PIC) is attached to a temporary carrier. In the fabrication step corresponding to FIG. 4B, the backside of the PIC is ground. In the fabrication step corresponding to FIG. 4C, conductive pads are formed on the ground backside of the PIC. In the fabrication step corresponding to FIG. 4D, application-specific integrated circuits (ASICs) and glass couplers are attached to the PIC. In the fabrication step corresponding to FIG. 4E, a capping structure is attached to the ASICs. In the fabrication step corresponding to FIG. 4F, the temporary carrier is removed. In the fabrication step corresponding to FIG. 4G, the packaged is attached to a permanent substrate. In the fabrication step corresponding to FIG. 4H, fiber array units (FAUs) are attached to the package.

### DETAILED DESCRIPTION

Described herein are fiber-connection structures for photonic integrated circuits (PICs). These fiber connection structures enable efficient optical coupling between integrated waveguides and corresponding optical fibers by facilitating reliable edge coupling. The fiber-connection designs developed by the inventor improve upon conventional approaches by increasing fan-out fiber capability, coupling efficiency and scalability.

Photonic integrated circuits (PICs) are commonly fabricated on silicon-on-insulator (SOI) wafers and may include active and passive components such as lasers, modulators and detectors. The integration of these components on a single chip enables higher operating speed and lower power consumption. These chips often employ optical mode converters to couple light between on-chip silicon waveguides and optical fibers. The inventors have recognized and appreciated that conventional coupling approaches are increasingly inadequate as data rate and size requirements continue to scale.

To address these challenges, the inventors have developed glass couplers (also referred to herein as “wing couplers” or “glass-wing couplers”) designed to facilitate optical fan-out. Optical fan-out refers to coupling light from tightly spaced on-chip waveguides to external fibers. This often involves increasing the pitch between channels, enabling compatibility with larger pitch fiber arrays. The approach developed by the inventors and described herein leverages the low-loss characteristics of glass photonic waveguides to extend optical routing distance while decoupling electrical and optical paths.

In some embodiments, a PIC is etched to position the glass coupler closer to the on-chip waveguides, improving coupling efficiency. Some embodiments support tight-pitch, high-density optical fan-out, thereby improving the overall bandwidth density. In addition to simplifying optical routing, some embodiments further improves performance by mitigating issues associated with C4 attach (e.g., solder attachment of the PIC to the substrate), offering a more scalable and robust solution for optical communication.

Some embodiments improve upon conventional approaches in one or more respects, examples of which are now described. Some embodiments improve coupling efficiency. Etching of the PIC to form a recess reduces the separation between the glass waveguide and the PIC waveguide, thereby reducing optical losses. Some embodiments improve fan-out capabilities. The glass coupler architecture provides a larger shoreline for optical fan-out, enabling tight-pitch, high-density interconnects. Some embodiments permit evanescent coupling between glass waveguides and PIC waveguides, improving optical alignment tolerances. Some embodiments decouple electrical routing from optical routing. Use of glass couplers simplifies integration and avoids conflicts between electrical routing and optical routing. Some embodiments reduce issues associated with C4 attach, improving manufacturability and routing flexibility. Some embodiments support scalable optical distribution and improved co-integration with electronic systems, helping reduce footprint and costs. Some embodiments provide compatibility with fabrication of conventional printed circuit boards (PCBs), further improving manufacturing yields.

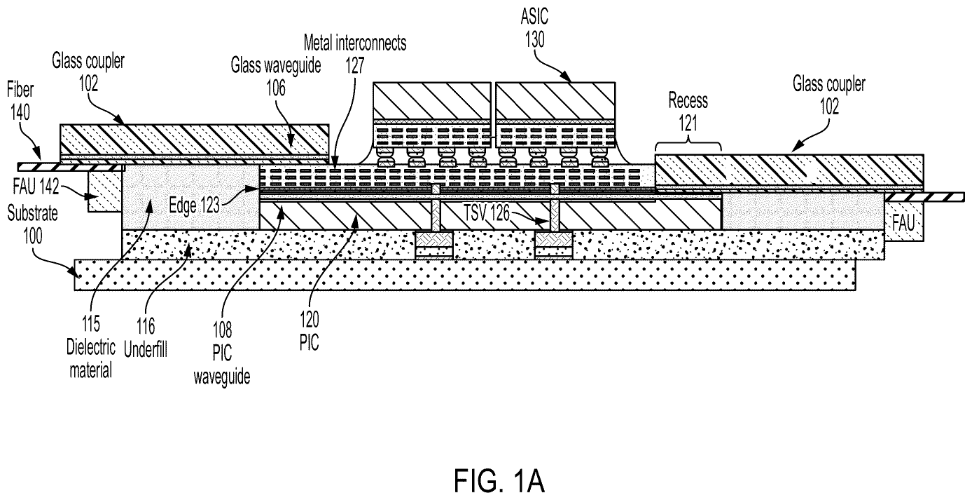

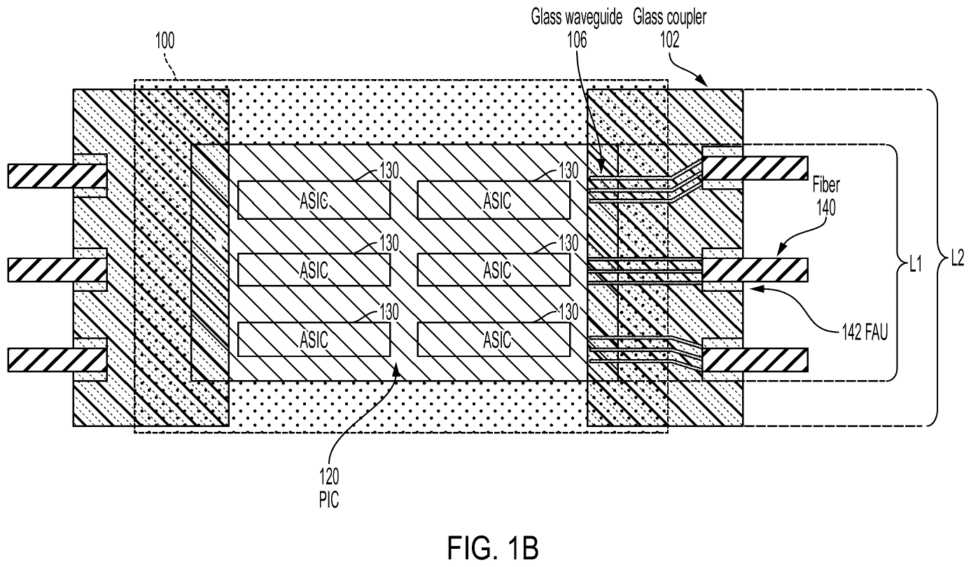

FIG. 1A is a cross sectional side view of a package including glass couplers arranged in accordance with the techniques described herein. The package of FIG. 1A includes a substrate 100. Substrate 100 may be a printed circuit board (PCB) or an organic substrate, for example. Substrate 100 is configured to route signals generated inside the package to external devices and vice versa. A photonic integrated circuit (PIC) 120 is disposed on substrate 100. PIC 120 may be active in nature in that it may include modulators, photodetectors and/or optical switches. In one example, PIC 120 may be equipped with optical switches to route data to (and from) other PICS disposed on the substrate. PIC 120 may further include a network of PIC waveguides. PIC waveguide 108, for example, extends to or near the edge 123 of PIC 120. As such, an end of PIC waveguide 108 is adjacent to edge 123. In some embodiments, PIC 120 is made of silicon and PIC waveguide 108 may be made of silicon or silicon nitride.

PIC 120 further includes metal interconnects 127, which include several levels of metal traces interconnected to one another by vias (e.g., tungsten vias). Metal interconnects 127 distribute electrical signals between electronic circuitry formed in the PIC (e.g., modulator drivers, trans-impedance amplifiers, semiconductor junctions, heaters, etc.) and application-specific integrated circuits (ASICs) 130, examples of which are described below. PIC 120 may be patterned so that metal interconnects 127 are between waveguides 108 and the PIC's top surface.

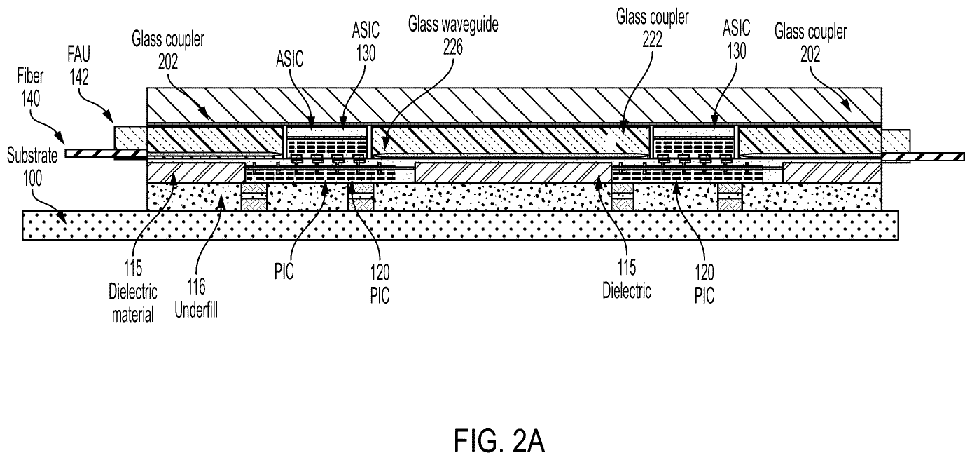

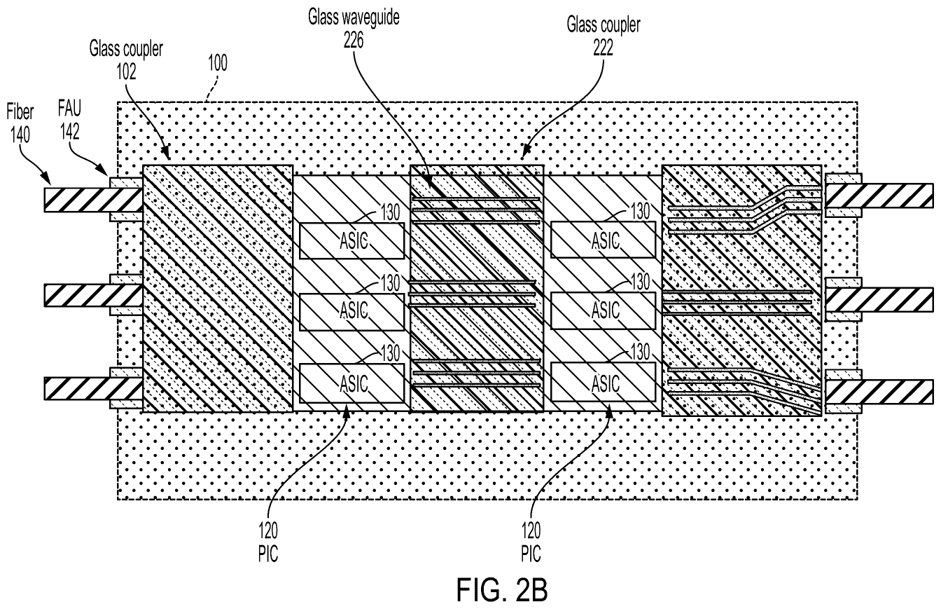

The orientation of PIC 120 on substrate 100 may be upright or flipped. In the implementation of FIG. 1A, PIC 120 is oriented in the upright position-the PIC's top surface is on the top side and the PIC's back surface is on the bottom side, near substrate 100. As a result, PIC waveguides 108 and metal interconnects 127 are positioned near the top side. In other implementations (e.g., FIG. 2A), a PIC 120 may be flipped (i.e., the PIC's top surface is on the bottom side and the PIC's back surface is on the top side, away from substrate 100). As a result, PIC waveguides 108 and metal interconnects 127 are positioned near the bottom side. In the implementations in which PIC 120 is flipped, the PIC's back surface may be thinned, thereby providing electrical access through the top side.

An underfill 116 fills the gap between the back surface of PIC 120 and substrate 100. Underfill 116 may be made of epoxy or a capillary underfill (CUF). Through-silicon vias (TSV) extending through the PIC's substrate in the vertical direction electrically couple the PIC's circuitry to substrate 100. A dielectric material 115 is formed near the outer edges of PIC 120. Dielectric material 115 may be made of the same material as underfill 116 in some embodiments, thereby forming a continuous material. Alternatively, dielectric material 115 may be made of silicon dioxide.

PIC 120 supports one or more ASICs 130. In the arrangements of FIG. 1A, a pair of ASICs is disposed on PIC 120, although any other suitable number of ASICs per PIC may be used. Because PIC 120 is in the upright position, with metal interconnects 127 positioned near the top side, the ASICs may be bonded to the PIC using conventional techniques, such as solder bonding. Each ASIC may include processing circuitry and/or memory circuitry, for example. The processing circuitry may be implemented as a central processing unit (CPU), a graphic processing unit (GPU), a field programmable gate array (FPGA), an accelerator, etc. The memory circuitry may be implemented as a high-bandwidth memory (HBM), for example. Collectively, the ASICs form a computer system including multiple processing units and multiple memory devices that are optically interconnected with one another through PICs.

The package further includes glass couplers 102 to optically couple PIC 120 to external optical fibers. Glass couplers 102 are attached to the same surface of PIC 120 on which ASICs 130 are also attached. Glass couplers 102 may be made of any suitable type of glass, including for example SiO₂, fused silica, or borosilicate glass. The glass couplers may be passive in nature in that they may include passive optical devices (e.g., waveguides, passive couplers, waveguide crossings, wavelength multiplexers/demultiplexers, etc.) but may omit active optical devices (e.g., modulators, detectors, switches, etc.). Glass waveguides 106 may be used to route light within the glass couplers, thereby forming a network optically coupling the PIC to external fibers. The waveguides can be made in-situ within the glass coupler itself with lithography or laser writing. In another embodiment, the waveguides and the passive optical components within the glass couplers can be manufactured using an ion-exchange process. Different glass compositions can necessitate different manufacturing techniques. Further, the waveguides may be made of a material having a refractive index greater than the refractive index of the surrounding material, thus ensuring that the optical mode is sufficiently contained and guided within the waveguide. For example, the glass couplers may be made of SiO₂, and the waveguides may also be made of SiO₂, but doped to produce a larger refractive index, or may be made of silicon nitride. The silicon nitride can either be grown, deposited, or bonded.

Each glass coupler 102 is formed as a discrete component that is attached to PIC 120. As such, glass couplers 102 are spaced apart from each other. The glass couplers of FIG. 1A embody two different configuration options. This depiction is intended to demonstrate that various arrangements may be used when attaching glass couplers to a PIC. For example, a device may be packaged with all the glass couplers in the configuration shown on the left side of FIG. 1A, or alternatively, in the configuration shown on the right side of FIG. 1A. In the configuration shown on the left side of FIG. 1A, glass coupler 102 is attached to the top surface of PIC 120. Given the vertical separation between glass waveguide 106 and PIC waveguide 108, the waveguides are evanescently coupled to each other. The waveguides are said to be evanescently coupled to one another in that they lie on different planes. Coupling may be achieved using tapers, whereby the optical mode is expanded as it travels closer to the boundary between the PIC and the glass coupler. This configuration results in a relatively large vertical separation between glass waveguide 106 and PIC waveguide 108. In the configuration shown on the right side of FIG. 1B, glass coupler 102 is moved closer to the PIC waveguide. This is achieved by placing glass coupler 102 in a recess 121 that has been etched on the top surface of PIC 120. The etching step may remove at least a portion of metal interconnects 127, thus allowing glass waveguide 106 to come closer to PIC waveguide 108. As a result, the vertical separation between glass waveguide 106 and PIC waveguide 108 is reduced, thereby improving the coupling efficiency. In some embodiments, the vertical separation between glass waveguide 106 and PIC waveguide 108 may be less than 10 μm in this arrangement, less than 5 μm or even less than 3 μm.

In both configurations, an external optical assembly is attached on the opposite side of the glass couplers relative to the PIC. Each optical assembly includes a fiber array unit (FAU) 142 attached to an optical fiber 140. In the implementation of FIG. 1A, glass waveguides 106 are shown as being on different planes relative to the core of fiber 140. As a result, glass waveguides 106 is evanescently coupled to fiber 140. In other implementations, glass waveguides 106 and fiber 140 may be co-planar. The portions of glass couplers 102 that are not attached to PIC 120 may rest on top of dielectric material 115. It should be noted that while FIG. 1A illustrates a single fiber 140 coupled to an edge of a PIC, to increase the data rate, some embodiments use an array of fibers coupled to the same edge of the PIC.

FIG. 1B is a top view of the package of FIG. 1A. FIG. 1B illustrates that use of glass couplers of the types described herein increases the package shoreline, thereby increasing the optical fan-out capabilities. The edge of PIC 120 has a first length L1, and the edge of the glass coupler to which FAUs 142 are attached has a second length L2. As shown, L2 is greater than L1, thereby increasing the shoreline of the package available for optical fan-out.

It should also be noted that six ASICs are disposed on top of PIC 120 in this implementation, although any other suitable number of ASICs is possible.

FIGS. 2A-2B illustrate an alternative package arrangement. In this arrangement, each PIC 120 is flipped—the PIC's top surface is on the bottom side and the PIC's back surface is on the top side, away from substrate 100. To enable this arrangement, the substrate of each PIC has been ground, thereby exposing TSVs. As such, the PICs may be relatively thin (e.g., between 10 μm and 50 μm, between 20 μm and 50 μm, between 30 μm and 50 μm, between 40 μm and 50 μm, between 10 μm and 40 μm, between 20 μm and 40 μm, between 30 μm and 40 μm, between 10 μm and 30 μm, between 20 μm and 30 μm or between 10 μm and 20 μm). Due to the orientation of the PIC, ASIC-PIC bonding may not be performed using solder bonding. Instead, hybrid bonding or fusion bonding techniques may be used.

The arrangement of glass couplers 202 may be similar to the arrangement of glass couplers 102 of FIG. 1A. Instead of being attached to the top surface of the PICS, however, they are attached to the back surfaces of the PICs, which have been ground. Recesses may be formed on the PICs'back surfaces to reduce the vertical separation between the PIC waveguides and the glass waveguides, similar to the configuration shown on the right side of FIG. 1A.

In addition to glass couplers 202, this implementation includes glass coupler 222, which facilitates optical coupling between adjacent PICs. In essence, glass coupler 222 operates as an optical bridge. Glass coupler 222 is disposed on top of dielectric material 115, in the region between adjacent PICs 120. A waveguide 226 formed inside glass coupler 222 optically couples a PIC waveguide of one of the PICs to a PIC waveguide of the other PIC. It should be noted that optical bridges of the type illustrated in FIG. 2A are not unique to the implementation of FIG. 2A, and may be used in connection with the implementation of FIG. 1A as well.

FIG. 2B is a top view of the package of FIG. 2A. As in the example of FIG. 1B, FIG. 2B illustrates that use of glass couplers of the types described herein increases the package shoreline, thereby increasing the optical fan-out capabilities. To that end, the edges of glass couplers 222 are longer than the corresponding edges of PICs 120.

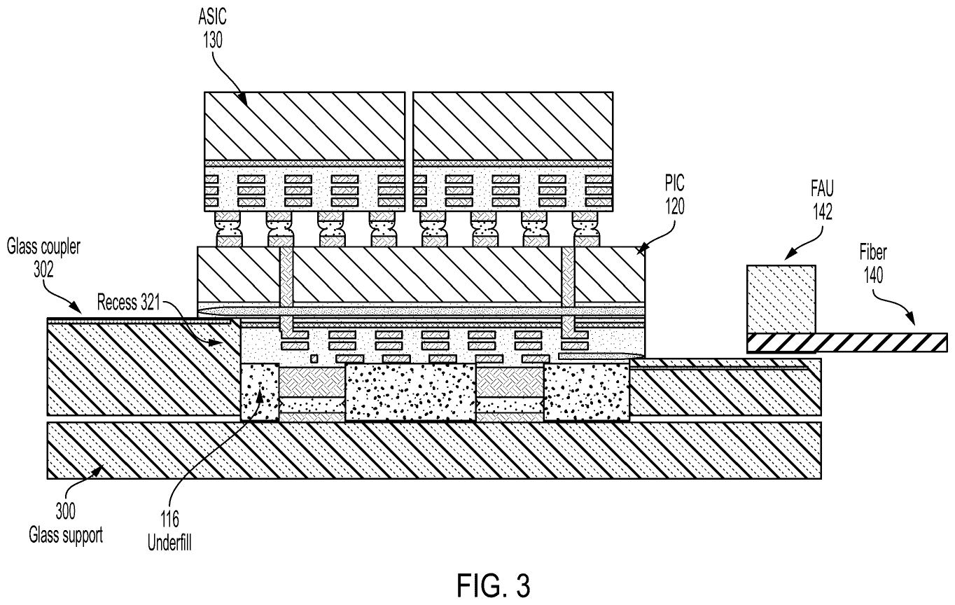

FIG. 3 illustrates a further package arrangement. The package of FIG. 3 is similar to the package of FIG. 2A in that the PIC is flipped. Further, the arrangement of glass couplers 302 is similar to the arrangement of glass couplers of FIG. 2A in that they provide access to external fibers. Unlike the arrangement of FIG. 2A, however, the arrangement of FIG. 3 includes a glass support 300 attached to substate 100 (not shown in FIG. 3). Here, PIC 120 is disposed on glass support 300. Glass support 300 extends laterally far enough to provide a surface on which glass couplers 302 can rest. It should be noted that glass support 300 and glass couplers 302 are fabricated as separate pieces which are ultimately attached together, for example using glue or epoxy. Through-glass vias (TGVs) extending inside the glass support in the vertical direction electrically couple PIC 120 to substrate 100.

Fabricating glass support 300 and glass couplers 302 as separate pieces offers advantages over fabricating them monolithically (e.g., as a single glass interposer). Pre-forming TGVs in the glass support is significantly easier than forming TGVs in a full glass interposer, because the glass support is thinner than an equivalent interposer.

Similar to what was described in connection with FIG. 1A, the glass couplers of FIG. 3 embody two possible configuration options. Again, this depiction is intended to demonstrate that various arrangements may be used when attaching glass couplers to a PIC. For example, a device may be packaged with all the glass couplers in the configuration shown on the left side of FIG. 3, or alternatively, in the configuration shown on the right side of FIG. 3. In the configuration shown on the right side of FIG. 3, glass coupler 302 is attached to the top surface of PIC 120. In the configuration shown on the left side of FIG. 3, glass coupler 302 is moved closer to the PIC waveguide. This is achieved by placing glass coupler 302 in a recess 321 that has been etched on the top surface of PIC 120. As a result, the vertical separation between the glass waveguide and PIC waveguide is reduced, thereby improving the coupling efficiency.

Though not shown in FIG. 3, this implementation may further include glass couplers operating as optical bridges, as described in connection with FIG. 2A.

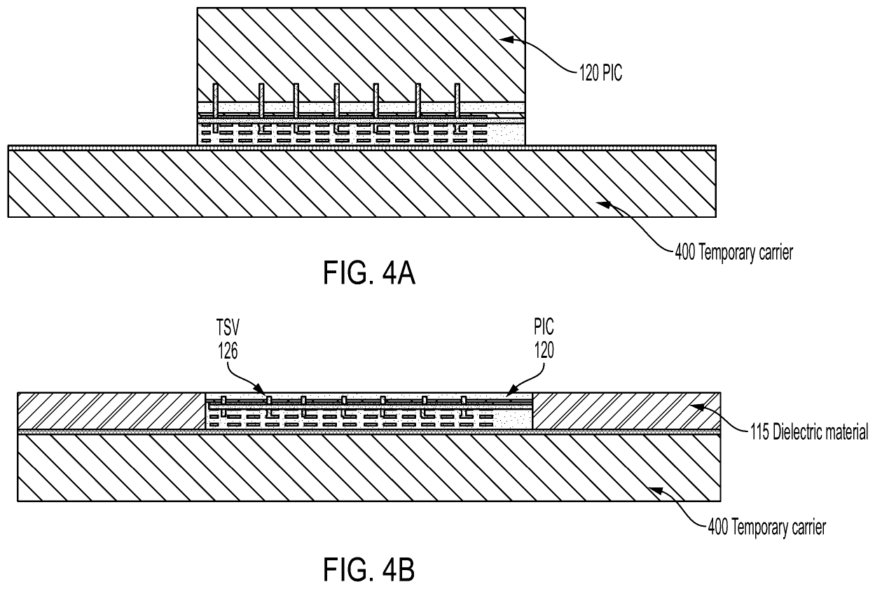

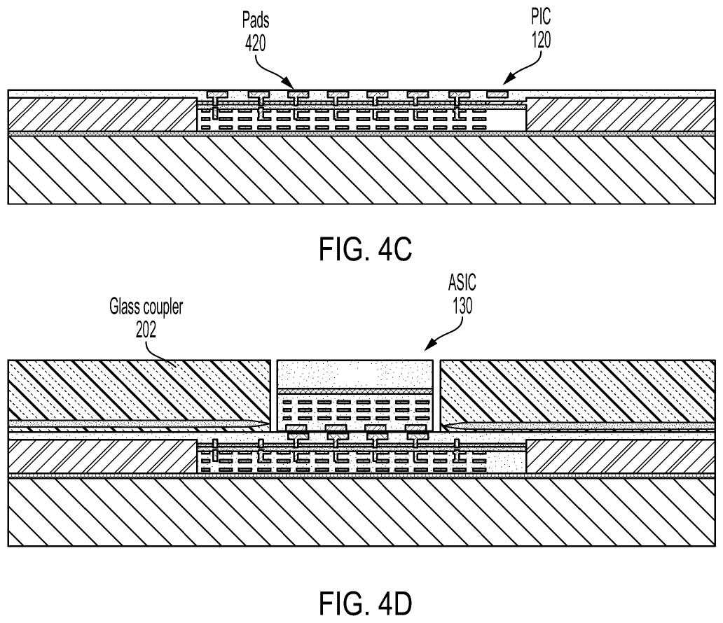

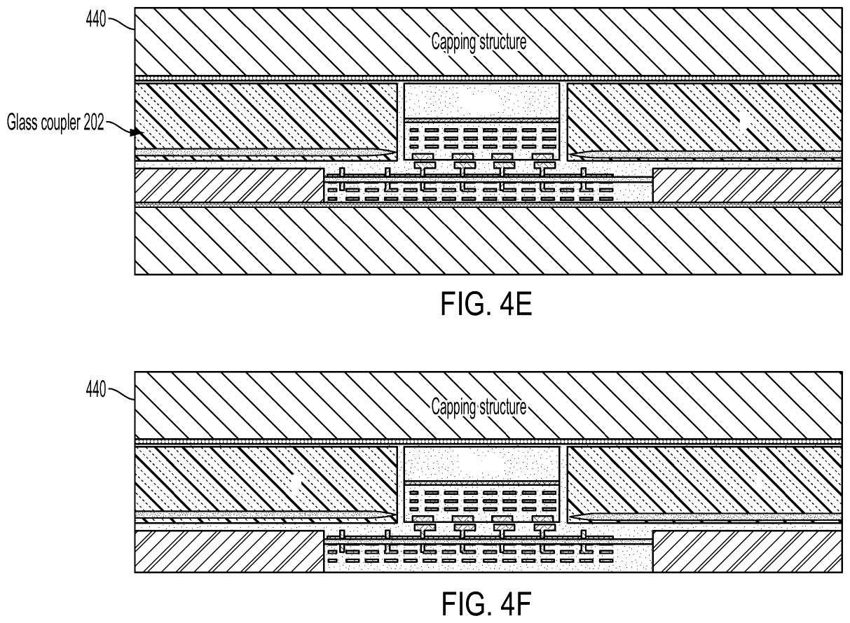

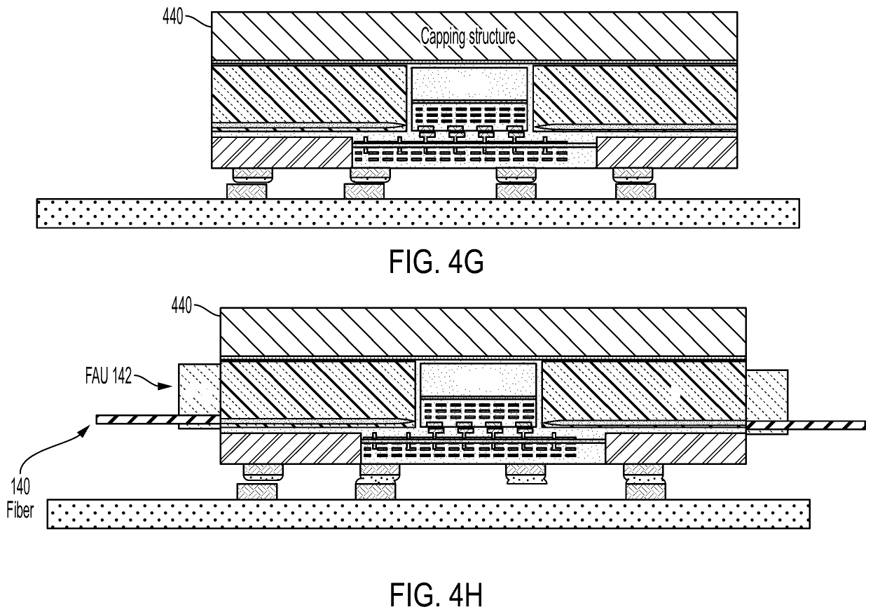

FIGS. 4A-4H are cross sectional views illustrating a process for fabricating the package of FIG. 2A, in accordance with some embodiments. Similar methods may be used to fabricate the other packages described herein. In the fabrication step corresponding to FIG. 4A, a PIC 120 is attached to a temporary carrier 400. As shown, PIC 120 is flipped (i.e., the PIC's top surface is on the bottom side and the PIC's back surface is on the top side, away from temporary carrier 400). In the fabrication step corresponding to FIG. 4B, the backside of the PIC 120 is ground, thereby exposing TSVs 126. A dielectric material 115 is formed near the outer edges of PIC 120, and a planarization step is performed to level the exposed surface of the device. In the fabrication step corresponding to FIG. 4C, conductive pads 420 are formed on the ground backside of the PIC. Conductive pads 420 are electrically coupled with TSVs 126, thereby providing external access to the PICs internal electronic circuitry. In the fabrication step corresponding to FIG. 4D, ASICs 130 and glass couplers 202 are attached to PIC 120. Once attached, ASICs 130 and glass couplers 202 are disposed side-by-side, on the same surface of PIC 120. In the resulting configuration, waveguides in the glass couplers 202 are optically coupled to waveguides in PIC 120, and ASIC 130 is electrically coupled to conductive pads 420. In the fabrication step corresponding to FIG. 4E, a capping structure 440 is attached to the top surface of ASICs 130. Capping structure 440 may be made of silicon, for example, although other materials may be used. Capping structure 440 covers the ASIC and the glass couplers, protecting the package from external agents. In the fabrication step corresponding to FIG. 4F, temporary carrier 400 is removed. In the fabrication step corresponding to FIG. 4G, the package is attached to a substrate 100. Optionally, the gap between PIC 120 and substrate 100 may be filled with underfill (not shown in FIG. 4G). Lastly, in the fabrication step corresponding to FIG. 4H, fiber assemblies (including fibers 140 and FAUs 142) are attached to the package.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than described, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

What is claimed is:

1. A photonic package, comprising:
a substrate;
a first photonic integrated circuit (PIC) attached to the substrate, wherein the first PIC comprises a PIC waveguide having an end adjacent an edge of the first PIC;
an application-specific integrated circuit (ASIC) attached to the first PIC, wherein the ASIC and the first PIC are electrically coupled to one another; and
a glass coupler attached to the first PIC, the glass coupler comprising a glass waveguide optically coupled to the PIC waveguide.

2. The photonic package of claim 1, wherein the ASIC and the glass coupler are attached to a same surface of the first PIC.

3. The photonic package of claim 1, further comprising a dielectric material near the edge of the first PIC, wherein the glass coupler is disposed in part on the dielectric material.

4. The photonic package of claim 1, wherein the glass waveguide and the PIC waveguide are on different planes and are coupled to each other evanescently.

5. The photonic package of claim 1, wherein the glass waveguide and the PIC waveguide are separated by less than 10 um.

6. The photonic package of claim 1, wherein the first PIC is less than 50 um in thickness, and wherein the first PIC comprises a through silicon via (TSV) coupled to the ASIC.

7. The photonic package of claim 1, wherein the first PIC defines a recess and wherein the glass coupler is partially disposed in the recess.

8. The photonic package of claim 1, further comprising an optical assembly comprising an optical fiber attached to a fiber array unit (FAU), wherein the glass coupler optically couples the optical assembly to the first PIC.

9. The photonic package of claim 8, wherein the edge of the first PIC has a first length, and wherein the optical assembly is attached to an edge of the glass coupler, wherein the edge of the glass coupler has a second length greater than the first length.

10. The photonic package of claim 1, further comprising a second PIC attached to the substrate, wherein the second PIC comprises a PIC waveguide having an end adjacent an edge of the second PIC, wherein:
the glass coupler is disposed between the first PIC and the second PIC, and
the glass waveguide optically couples the PIC waveguide of the first PIC to the PIC waveguide of the second PIC.

11. The photonic package of claim 1, further comprising a glass support, wherein the first PIC and the glass coupler are attached to the glass support.

12. A photonic package, comprising:
a substrate;
first and second photonic integrated circuits (PICs) attached to the substrate;
a first application-specific integrated circuit (ASICs) attached to the first PIC and a second ASIC attached to the second PIC;
an optical assembly comprising an optical fiber attached to a fiber array unit (FAU);
a first glass coupler attached to the first PIC, the first glass coupler optically coupling the optical assembly to the first PIC; and
a second glass coupler attached to the first and second PICs, the second glass coupler optically coupling the first PIC to the second PIC.

13. The photonic package of claim 12, wherein the first ASIC, the first glass coupler and the second glass coupler are attached to a same surface of the first PIC.

14. The photonic package of claim 12, wherein the first glass coupler and the first PIC are coupled to each other evanescently.

15. The photonic package of claim 12, wherein:
an edge of the first PIC, to which the first glass coupler is attached, has a first length, and
the optical assembly is attached to an edge of the first glass coupler, wherein the edge of the first glass coupler has a second length greater than the first length.

16. The photonic package of claim 12, wherein the first PIC is less than 50 um in thickness, and wherein the first PIC comprises a through silicon via (TSV) coupled to the first ASIC.

17. A method for fabricating a photonic package, the method comprising:
obtaining a photonic integrated circuit (PIC) having a PIC waveguide and a through silicon via (TSV), and obtaining a glass coupler having a glass waveguide;
exposing the TSV by grinding the PIC;
forming a conductive pad electrically coupled with the TSV;
attaching an application-specific integrated circuit (ASIC) on the PIC such that the ASIC is electrically coupled to the conductive pad;
attaching the glass coupler to the PIC such that the glass waveguide is optically coupled to the PIC waveguide; and
attaching a fiber to the glass coupler such that the glass waveguide is optically coupled to the fiber.

18. The method of claim 17, further comprising attaching a capping structure on the ASIC such that the capping structure covers the ASIC and the glass coupler.

19. The method of claim 17, wherein attaching the glass coupler to the PIC comprises attaching the glass coupler to a recess formed in the PIC.

20. The method of claim 17, wherein upon attaching the glass coupler to the PIC, the glass waveguide is evanescently coupled to the PIC waveguide.
